(19) United States
(12) Patent Application Publication
(10) Pub. No.: US 2023/0031569 A1
(43) Pub. Date: Feb. 2, 2023

(54) APPARATUS AND METHOD OF LASER SCANNING

(71) Applicant: STMICROELECTRONICS S.r.l., Agrate Brianza (IT)

(72) Inventor: Daniele CALTABIANO, Milano (IT)

(73) Assignee: STMICROELECTRONICS S.r.l., Agrate Brianza (IT)

(21) Appl. No.: 17/864,217

(22) Filed: Jul. 13, 2022

(30) Foreign Application Priority Data
Jul. 27, 2021 (IT) 102021000020006

(51) Int. Cl. G01S 17/89; G01S 17/06; G01S 7/481

(52) U.S. Cl. CPC G01S 17/89; G01S 17/06; G01S 7/4817; G01S 17/931

(57) ABSTRACT

An apparatus, comprising: a laser light source configured to transmit at least one beam of light pulses towards a target, projecting at least one corresponding beam spot thereon, and an array of sensors with a plurality of sensors distributed according to a grid, a sensor in the array of sensors configured to sense a light pulse incident thereon in response to reflection of at least one light pulse of the beam of light pulses from a field of view, FOV, region in the target, the sensor of the array of sensors further configured to provide a signal indicative of a time of incidence of at least one light pulse. A FOV region of the array of sensors is portioned into grid cells according to the grid. Each sensor in the array of sensors is configured to sense at least one echo light pulse reflected from a respective grid cell portion of the FOV region. The apparatus comprises a beam steering arrangement configured to cyclically vary a direction of transmission of the beam of light pulses, projecting at least one light pulse per grid cell in the portioned FOV region of the array of sensors.

### BACKGROUND

### Technical Field

The description relates to systems for scanning a multidimensional (e.g., 2D or 3D) environment, such as laser scanners or LIDARs, for instance.

One or more embodiments may be used in robot or vehicle autonomous navigation systems, for instance.

### Description of the Related Art

An electronic system configured to measure a distance from the surroundings by measuring the time of flight (TOF) of a laser beam, that is the time taken for a light pulse to travel from a light source to a target and back (echo), is known as a light detection and ranging (briefly, LIDAR) or laser scanner system.

In order to obtain a TOF measurement, a time to digital (TDC) converter device may be employed, that is a device configured to measure (e.g., with sub-nanosecond accuracy) a time interval elapsed between two digital signals, such as the transmitted light pulse and the light echo signals of the LIDAR, for instance.

A TOF measurement can be obtained in a direct or indirect way, for instance.

A direct time of flight (dTOF) measurement uses a phase detector device configured to detect a phase shift between the transmitted laser light pulse and the light echo signal, wherein distance of the target is determined by the shift times (half) the speed of light.

An indirect time of flight (iTOF) measurement does not measure the phase shift directly but it obtains it from detecting the number of photons (or light intensity) during the pulse/modulation period of the light signal.

Laser scanner systems can be used to build maps of objects and landscapes by scanning 2D or 3D environments and acquiring multiple TOF measurements of the surroundings.

Existing laser scanners use alternative and divergent technical solutions to scan a 2D or 3D target.

For instance, some solutions involve controlled steering of laser beams on the target and taking a distance measurement at every steering direction.

For instance, a rotating electrical connector (e.g., a gimbal) may be used to sequentially scan different directions, that is an electromechanical device to facilitate transmission of power and electrical signals from a stationary to a rotating structure.

These solutions may be inconvenient for many applications due to, e.g.:
the presence of bulky elements such as the motor, mirror and/or rotating electrical connectors,
wear of the performance of these bulky parts,
relatively high-power consumption and limited operational frequency.

Single laser single sensor (briefly, SLSS) systems are also known. These systems comprise a pulsed laser source, an optical scanning arrangement (e.g., a first and a second mirror configured to rotate along a first and a second axis, respectively, with the first and the second axes orthogonal therebetween) and a light sensor configured to measure the TOF for each light pulse.

In SLSS systems the laser source 12 is pulsed with a pulse time interval greater than a maximum distance (or ToF) which can be measured, in order to prevent any ambiguity in the TOF measurement This is a drawback of SLSS in that it limits the throughput and the applicability of the system 10, in particular for relatively high distances.

An alternative solution is the so-called “flash LIDAR” arrangement. This involves “flashing” illuminate a full scene of the target by coupling a diffractive optics (briefly, DOE) arrangement to the laser source and using a grid-like sensing arrangement, with each sensor in the grid arrangement dedicated to calculating the ToF of the light beam echoed from a corresponding part of the illuminated full scene.

This flash LIDAR arrangement may be inconvenient for many applications due to, e.g.:
the mapping resolution depends on the resolution of each sensor of the array of sensors,
high power consumption and expensive sensors are involved to obtain an adequate resolution of the environment,
the laser power used to illuminate the scene increases quadratically with the distance and linearly with the number of grid points, practically limiting a maximum application distance within a short range (e.g., 5 to 10 meters).

Existing sensors may involve additional reset signals and present a limited throughput.

### BRIEF SUMMARY

One or more embodiments contribute in overcoming the aforementioned drawbacks.

According to one or more embodiments, a LIDAR apparatus includes a laser source, a beam steering arrangement (e.g., MEMS lenses or mirrors or optical phase arrays—OPAs) and an array of sensors, wherein each sensor of the array is focused on a determined region of the target or field of view may be exemplary of such an apparatus.

One or more embodiments may relate to a corresponding method.

In one or more embodiments, sensor parallelism provides improved figures of merit (resolution, framerate and maximum distance, for instance).

In one or more embodiments, sensor resolution may be a fraction of the final resolution, facilitating reducing cost and power consumption.

In one or more embodiments, a transmission path may be simplified, for instance thanks to a single laser source.

One or more embodiments may have a reduced size and weight, leading to cost savings and reduced power consumption.

One or more embodiments can speed up the frequency of the laser beam pulses thanks to the focusing of each sensor of the sensor array on a certain region of the field visual. For instance, laser pulses can be emitted sequentially without waiting, between sequential laser pulses, for the echo signal to be received by the sensor.

One or more embodiments may provide an innovative dual scanning, thanks to a reduced opening and speed of second stage (a lens in the example).

One or more embodiments may facilitate combining different technologies for different applications.

In one or more embodiments, exploiting MEMS technology facilitates providing a small, lightweight and fast system.

One or more embodiments may extend a ranging distance with respect to existing solutions, for instance increasing it from about 10 to about 100 meters.

### BRIEF DESCRIPTION OF THE SEVERAL VIEWS OF THE DRAWINGS

One or more embodiments will now be described, by way of non-limiting example only, with reference to the annexed Figures, wherein:

FIG. 1 is a diagram exemplary of an apparatus as per the present disclosure,

FIG. 2 is a diagram exemplary of a portion of the diagram of FIG. 1,

FIGS. 3 and 4 are diagrams exemplary of patterns suitable for use in one or more embodiments,

FIG. 5 is a diagram exemplary of principles underlying one or more embodiments,

FIG. 6 is a diagram exemplary of ways of combining image frames obtained according to the present disclosure,

FIGS. 7, 8, 9 and 10 are diagrams exemplary of alternative embodiments of an apparatus as per the present disclosure,

FIG. 11 is a diagram exemplary of a beam spot according to the embodiment of FIG. 10.

### DETAILED DESCRIPTION

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is comprised in at least one embodiment Hence, phrases such as “in an embodiment” or “in one embodiment” that may be present in one or more points of the present description do not necessarily refer to one and the same embodiment.

Moreover, particular conformations, structures, or characteristics may be combined in any adequate way in one or more embodiments.

The drawings are in simplified form and are not to precise scale.

Throughout the figures annexed herein, like parts or elements are indicated with like references/numerals and a corresponding description will not be repeated for brevity.

The references used herein are provided merely for convenience and hence do not define the extent of protection or the scope of the embodiments.

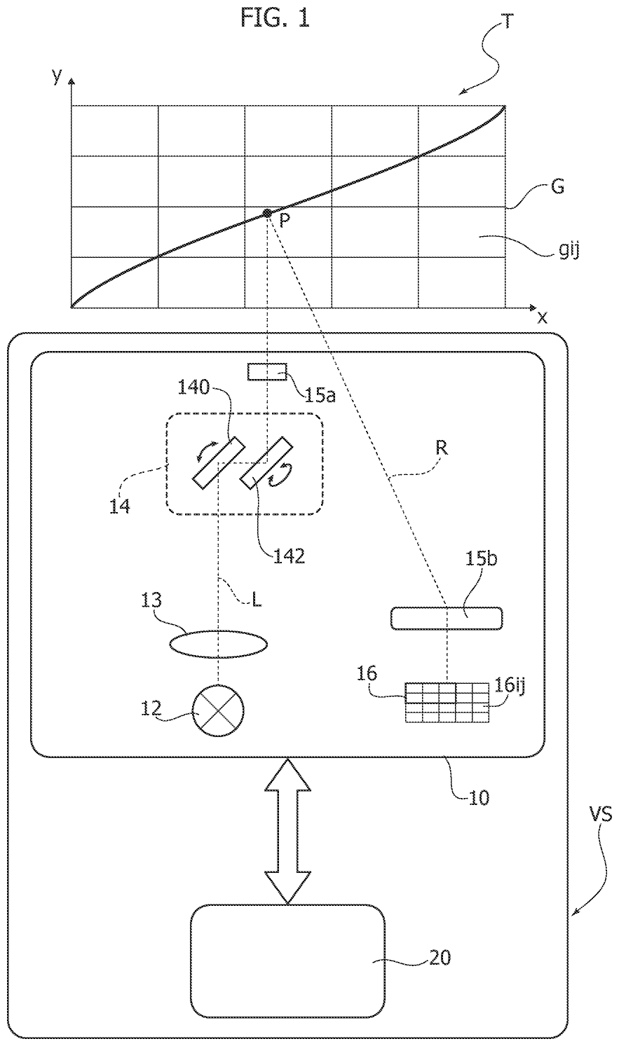

As shown as an example in FIG. 1, a laser scanner system or apparatus 10 comprises:
a light source 12, e.g., a pulsed laser source, configured to emit a light beam L,
In some embodiments, a beam shaping optics 13, e.g., a focusing lens 13, coupled to the light source 10, and configured to focus the light beam L,
a beam steering arrangement 14, comprising optical elements, is configured to controllably steer, via reflective and/or refractive phenomena, the (focused) light beam L from the light source 10, directing the light beam L towards a target scene T and projecting a pattern of light spots P thereon,
an array of sensors 16, the array of sensors 16 comprising a plurality of light sensors, where an ij-th light sensor 16ij of the plurality of light sensors or photodetectors is configured to detect an echo laser beam R reflected from a respective portion of the target surface T illuminated by the light spot P formed thereon.

As shown as an example in FIG. 1, in some embodiments, the system 10 further comprises at least one optical element 15a, 15b coupled to at least one of the beam steering arrangement 14 and the sensor array 16.

For instance:
a first optical element 15a is coupled to the scanning engine 14, and/or
a second optical element 15b is coupled to the sensor array 16.

In one or more embodiments, the first 15a and/or second 15b optical element is/are configured to correctly focus the target region in each sensor 16ij, and/or to compensate geometrical distortions occurring in the light projecting process via the arrangement 14, e.g., Keystone-Pincushion deformation, known per se.

As shown as an example in FIG. 1, the second optical element 15b comprises a filtering window configured to provide an aperture for the sensing array 16 and/or a focusing element, e.g., a lens arrangement, associated to each sensor 16ij in the array 16 focusing thereto the light filtered by the aperture.

In some embodiments, the known geometrical distortion can be compensated using a dedicated method of laser projection that properly select the (time and space) points in which the laser is pulsed. For instance, the control unit 20 may be configured to control the beam steering arrangement 14 and the laser source 12 in order to synchronize light pulse emission by the source 12 and position of the mirrors 140, 142, obtaining a compensated projection of the light pulse on the target scene T.

As shown as an example herein, the apparatus comprises at least one of:
a first optical element (for instance, 15a) coupled to the beam steering arrangement, the first optical element (for instance, 15a) interposed the beam steering arrangement and the target, and
a second optical element (for instance, 15b) coupled to the array of sensors, the second optical element interposed the target and the array of sensors.

For instance, the first and/or second optical elements are configured to counter a Keystone-Pincushion deformation during projecting at least one beam spot (for instance, P, P₁, P₁′) per grid cell (for instance, gᵢⱼ) in the portioned FOV region (for instance, T).

For the sake of simplicity, in the following the target surface T is considered to correspond to an entire field of view (briefly, FOV) of the laser scanner system 10, that is the angular extent of the field which can be observed with an optical instrument In the example considered, this FoV encompasses both to the area projected by the beam steering arrangement 14 and the area viewed by the array of sensors 16.

As shown as an example in FIG. 1, the apparatus 10 may be used in a navigation system VS on-board a vehicle (such as an autonomous wheeled vehicle). For instance, the control unit 20 may provide measurements of distance between a target object P and the vehicle to the navigation system VS in order to drive movements of the vehicle (e.g., controlling a speed of the wheels).

It will be once again recalled that the discussion of the apparatus as per the present disclosure within the framework of a vehicle/robot navigation system VS is merely examples provided for illustrative purposes and not limitative of the embodiments. An apparatus and method as described herein can also be used independently of any navigation system arrangement, and—more generally—in any area other than the field of navigation systems, such as augmented reality, visual support and graphical effects, for instance.

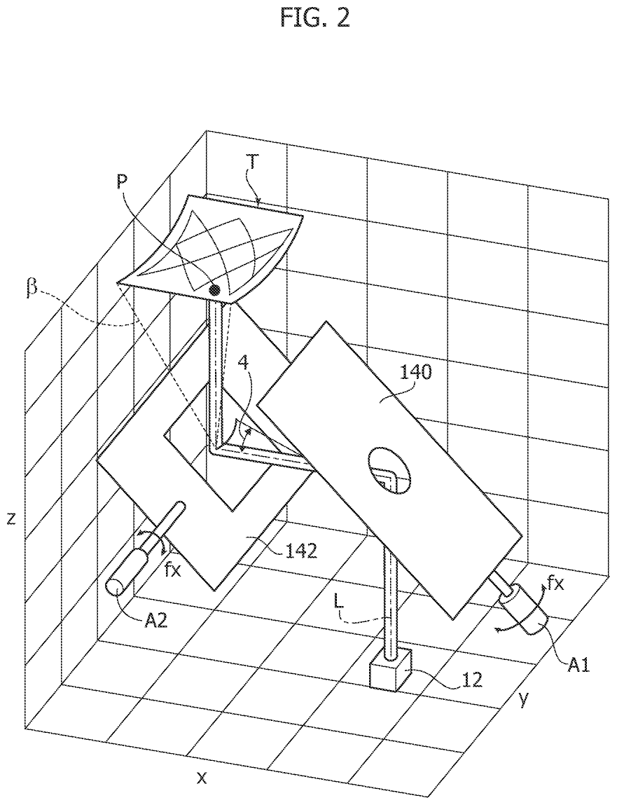

As shown as an example in FIGS. 1 and 2, the beam steering arrangement 14 comprises a set of optical components 140, 142 adapted to deflect and/or manipulate an incident laser beam L. For instance, the beam steering arrangement 14 comprise a first 140 and a second 142 conventional mono-axial micro-electromechanical mirrors (briefly, MEMS) each configured to rotate along a single axis (e.g., via respective actuators coupled to the mirrors), with respective rotational axes (generally) orthogonal therebetween (represented as abscissa x and ordinate y arrows in FIG. 1).

As shown as an example in FIG. 2, the mirrors 140, 142 are movable via respective actuators A1, A2 (illustrated in a completely schematic way in FIG. 2) configured to rotate the two mirrors 140, 142—and therefore the laser beam L deflected by them—along mutually perpendicular rotation.

As shown as an example in FIG. 2:
the first mirror 140 is configured to rotate along a first, e.g., horizontal, axis x, with a first frequency fₓ, varying a direction of the light beam L in a first, e.g., horizontal, plane xy, and steering the beam along a first angle α (e.g., α=±20°) as a result,
the second mirror 142 is configured to rotate along a second, e.g., vertical, axis y with a second frequency f_{y}, varying a direction of the laser beam L in a second, e.g., vertical, plane yz, and steering the beam along a second angle β (e.g., β=±15°).

In one or more embodiments, the beam steering arrangement 14 can also comprise multiple and/or different types of optical components, such as: prisms, lenses, diffraction gratings, beam-splitters, polarizers, expanders, and other components known per se, combined to allow the properties of the laser beam L to be controlled according to the present disclosure.

In one or more embodiments, the beam steering arrangement 14 may comprise biaxial MEMS mirrors each suitable to rotate along two orthogonal axes. For instance, biaxial MEMS mirrors may be suitable for use in one or more embodiments.

As shown as an example herein, an apparatus (for instance, 10), comprises:

a laser light source (for instance, 12) configured to transmit at least one beam of light pulses (for instance, L) towards a target, projecting at least one corresponding beam spot (for instance, P) thereon,
an array of sensors (for instance, 16) with a plurality of sensors (for instance, 16i, 16j, 16ij) distributed according to a grid (for instance, G), a sensor (for instance, 16i) in the array of sensors configured to sense a light pulse incident thereon in response to reflection of at least one light pulse (for instance, P, P₁, P₁′) of the beam of light pulses from a field of view, FOV, region (for instance, T) in the target, the sensor in the array of sensors further configured to provide a signal indicative of a time of incidence thereon of at least one light pulse (for instance, R, R′). For instance:
the FOV region (for instance, T) of the array of sensors is portioned into grid cells (for instance, gᵢⱼ) according to the grid,
each sensor in the array of sensors is configured to sense at least one echo light pulse reflected from a respective grid cell (for instance, g₁) in the portioned FOV region, and
the apparatus comprises a beam steering arrangement (for instance, 14) configured to cyclically vary a direction of transmission (for instance, α, β) of the beam of light pulses, projecting at least one beam spot per grid cell (for instance, gᵢⱼ) in the portioned FOV region.

As shown as an example herein, the beam steering arrangement comprises:
a first microelectromechanical, MEMS, mirror (for instance, 140) configured to oscillate around a first axis with a first oscillating angle (for instance, α), and
a second MEMS mirror (for instance, 142) configured to oscillate around a second axis with a second oscillating angle (for instance, β),
wherein each of the first MEMS mirror and the second MEMS mirror is coupled to a respective actuating device (for instance, A1, A2) configured to drive an oscillating movement of the respective mirror.

For instance, the first axis of oscillation of the first MEMS mirror and the second axis of oscillation of the second MEMS mirror are orthogonal therebetween.

In some embodiments, the beam steering arrangement 14 may comprise MEMS lenses in place of mirrors. For instance, MEMS lenses can be suitable for use and can provide a more compact solution with respect to those using mirrors.

As shown as an example herein, the beam steering arrangement further comprises a MEMS lens (for instance, 146) coupled to at least one of the first and second MEMS mirrors (140, 142), the MEMS lens configured to vary the direction of transmission of the light pulses (for instance, P1, P1′) within each grid cell (for instance, gᵢⱼ) in the portioned FOV of the array of sensors.

As shown as an example in FIG. 1, the array of sensors 16 can comprise a plurality of photodetectors, with each photodetector 16ij arranged as an element of a (e.g., 64×64) matrix of photodetectors 16.

For instance, the array of optical sensors 16 may comprise processing circuitry configured to apply signal processing to the detected echo laser beam R, providing a (e.g., pulse-by-pulse) ToF measurement.

As shown as an example in FIG. 1, driving circuitry 20 (e.g., a microcontroller or other processing circuitry) is coupled to the laser scanner system 10, for instance in order to drive the actuators A1, A2 to control movement of the mirrors 140, 142 of the beam steering arrangement 14, and/or to power the laser source 12, as well as to receive the time-of-flight measurement from the array of sensors 16.

As shown as an example in FIG. 1, a grid G is, in some implementations, superimposed onto the target T, the grid G configured to have a number of grid cells equal to the number of sensors of the array of sensors 16, the grid cells in the grid G arranged to reflect the same spatial arrangement of the sensors in the array of sensors 16.

In other words, the field of view T of the system 10 is treated as a grid G where each grid cell gᵢⱼ is in a one-to-one correspondence with each sensor 16ij of the array of sensors 16, that is an ij-th grid cell gᵢⱼ is detected by a corresponding ij-th sensor 16ij of the array of sensors 16.

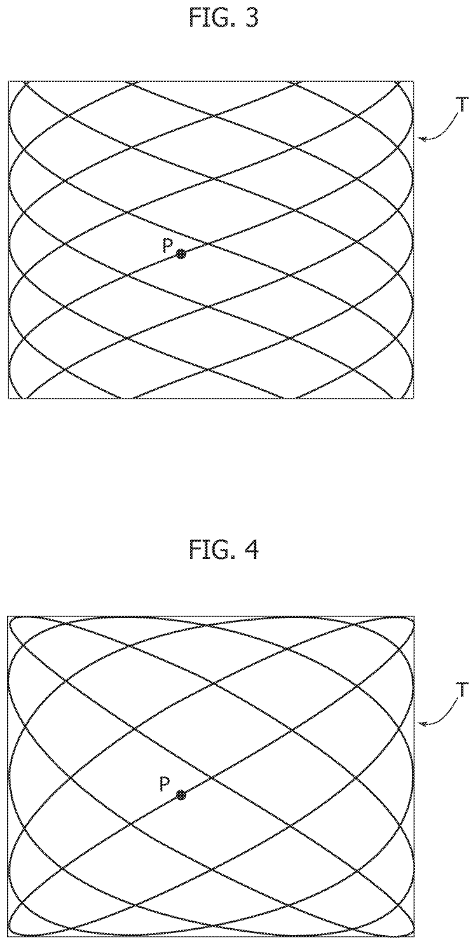

As shown as an example in FIGS. 1 and 2, the optical elements 140, 142 of the beam steering arrangement 14 may be controlled, e.g., via driving circuitry 20, to cyclically steer the, e.g., pulsed, light beam L from the source 12, so as to “draw” patterns such as those shown as an example in FIGS. 3 and 4 onto the target scene.

As shown as an example herein, the beam steering arrangement is configured to cyclically vary the direction of transmission of the light pulses according to a pattern, for example selected among a raster scan pattern and a Lissajous pattern.

FIG. 3 shows an example raster scan pattern which can be obtained by varying one of the first and second angles, e.g., the first angle α, is varied sinusoidally with time while the other, e.g., the second angle β, is varied (piece-wise) linearly with time, for example according to a triangular waveform, indicated as “tri” herein. This may be expressed as:

α=A*sin(2πt*fₓ+φₓ)

β=B*tri(2πt*f_{y}+φ_{y})

where φ_x and φ_y are respective initial angular position or phase values.

FIG. 4 shows a Lissajous pattern which can be obtained by varying the first angle α and the second angle β sinusoidally with time, at proper, e.g., resonant, frequencies. This may be expressed as:

α=A*sin(2πt*fₓ+φₓ)

β=B*sin(2πt*f_{y}+φ_{y})

For the sake of simplicity in illustration, an example case where the array of sensor comprises a number of nine sensors arranged as a column vector and focusing the attention on a single angle variation is used to illustrate principles of some of embodiments. It is otherwise understood that this example is purely illustrative and in no way limiting.

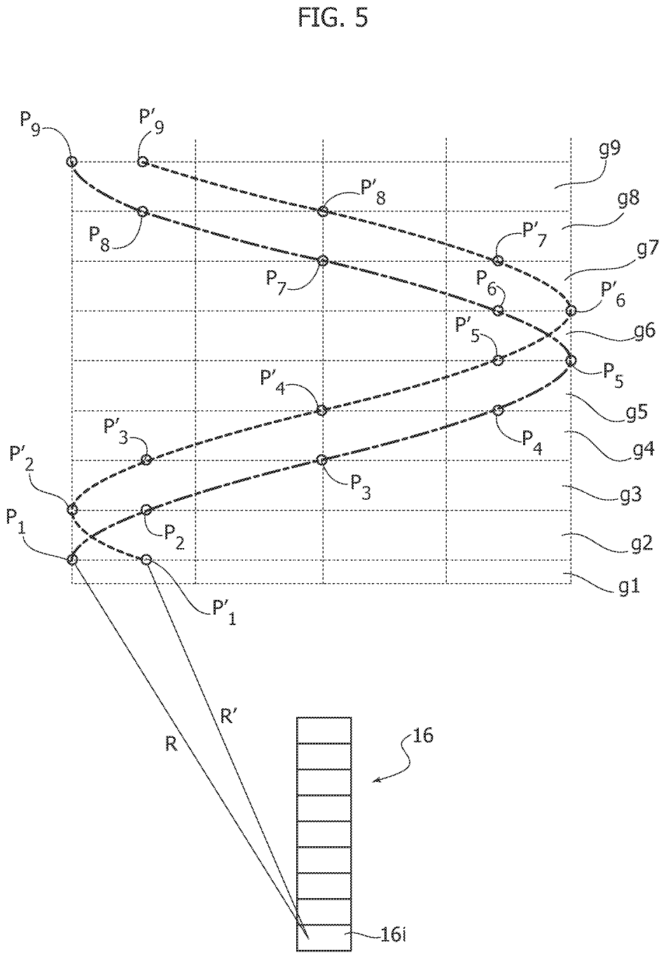

As shown as an example in FIG. 5, if the sensor array 16 comprises a column vector with nine sensors, the corresponding grid G configured to be superimposed to the target FOV T has nine grid cells g₁, g₂, . . . , gᵢ, . . . , g₈, g₉ arranged as a column vector.

As shown as an example in FIG. 5, in a first beam steering cycle of operating the beam steering arrangement 14:
the first mirror 140 is driven to vary sinusoidally the first angle a, while the second mirror 142 is driven to vary according to a linear (e.g., sawtooth) function (this first trajectory is represented in dashed line in FIG. 5, with α being horizontal, for instance),
the pulsed laser L is driven so that an i-th light spot (e.g., P₁) illuminates a respective i-th grid cell (e.g., g₁); correspondingly, an i-th sensor 16i of the sensor array 16 received the echo beam R from the i-th light pulse; consequently, the i-th sensor 16i computes the distance of the corresponding object in a respective portion (e.g., g₁) of the target scene T based on the (direct or indirect) ToF of the echo beam R.

As shown as an example in FIG. 5, in a second steering cycle of operating the beam steering arrangement 14, subsequent the first steering cycle:
the mirrors 140 and 142 are driven according to the same equations but varying the phases φₓ and φ_{y} (this second trajectory is represented in solid line in FIG. 5),
the pulsed laser L is again driven so that an i-th light spot (e.g., P₁′), for example in a different position with respect to the previous i-th light spot (e.g., P₁) for the same i-th grid cell (e.g., g₁), illuminating a “new” respective i-th grid cell location (e.g., g₁′); correspondingly, the i-th sensor 16i received a second echo R′ from the “new” i-th light pulse (e.g., P₁′) that illuminated that “new” portion of the target T; consequently, the i-th sensor 16ij sequentially detects more points referred to an object in a respective portion (e.g., g₁) of the (gridded G) target scene T.

For the sake of simplicity in illustration, in the example case of FIG. 5 the projection is considered to take place from bottom to top with the first light spot P1, P1′ for each cycle falling within the first grid element G1, being otherwise understood that the order may be reversed, with the raster scan being performed from top to bottom.

In one or more embodiments, the variation of the function to vary the first angle α, and/or second angle β, can comprise, for instance, varying the waveform equations, the phase (φₓ or φ_{y}):
e.g., randomly or piece-wise linearly or sinusoidally, and/or
selecting Lissajous pattern so that a full coverage of the target area T is obtained by overlapping of sub-Lissajous curves.

It is noted that, even varying the phase, a same area in the i-th grid element gᵢ may be illuminated multiple times in a number of cycles of beam steering 14, without this substantially affecting the resolution of the system 10.

In one or more embodiments, performance parameters, e.g., resolution, frame-rate and maximum target distance, can be tuned varying the vertical size of the sensor array 16 and the time to reposition the laser spot between two different trajectories.

In one or more embodiments, steering light pulses so that one light spot P1 per grid cell gᵢ is cyclically moved in a different area P1′ within the grid cell facilitates improving a global resolution of the apparatus. For instance, the resolution of the apparatus 10 is a function of the number of sensors 16i, 16ij in the sensor array 16 times a resolution of the cyclical variation of the position between subsequent steering cycles (“secondary” resolution).

For example, using a “secondary” resolution about 30×17 resolution in a sensor array 16 comprising a matrix of 64×64 sensors, the total system resolution reaches a value compatible with the standard ITU 709 or full high definition (briefly, FHD).

As shown as an example herein, at least one sensor (for instance, 16i) in the array of sensors comprises an avalanche photodiode, APD, or a single photon avalanche photodiode, SPAD.

In one or more embodiments, a single avalanche photodiode (briefly, APD) is found suitable for use as a sensor in the array of sensors 16.

An APD is a well-known semiconductor-based photodetector (that is, a photodiode) which is operated with a relatively high reverse voltage (e.g., just below breakdown) so that carriers excited by absorbed photons are strongly accelerated in the strong internal electric field, generating secondary carriers as a result. This triggers an avalanche process that effectively amplifies the photocurrent by a (controllable) amplification factor.

In some embodiments, arrays of Geiger-mode APDs, also referred to as single-photon avalanche diode, or briefly SPADs, may be suitable for use in the array of sensors 16. These are also semiconductor-based photodetectors (e.g., photodiodes), a detailed description of which is not provided herein for the sake of brevity.

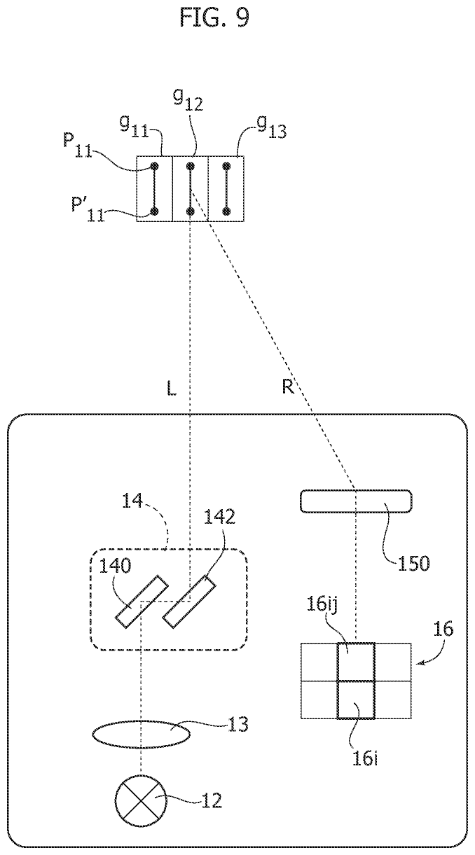

For instance, the array of sensors 16 can comprise a column vector whose elements comprise arrays of (e.g., sixteen) SPADs grouped together in order to provide a single ToF measurement (as discussed herein with reference to FIG. 9).

In one or more embodiments, a ST-Ed 256×256 SPAD imager produced by STMicroelectronics may be suitable for use as photodetector 16ij in the array of sensors 16.

One or more embodiments may perform multiple, partial scans of the target T with a given beam sweeping cycle and with a reduced sampling rate of the target scene, e.g., number of light spots used to illuminate it, per steering cycle.

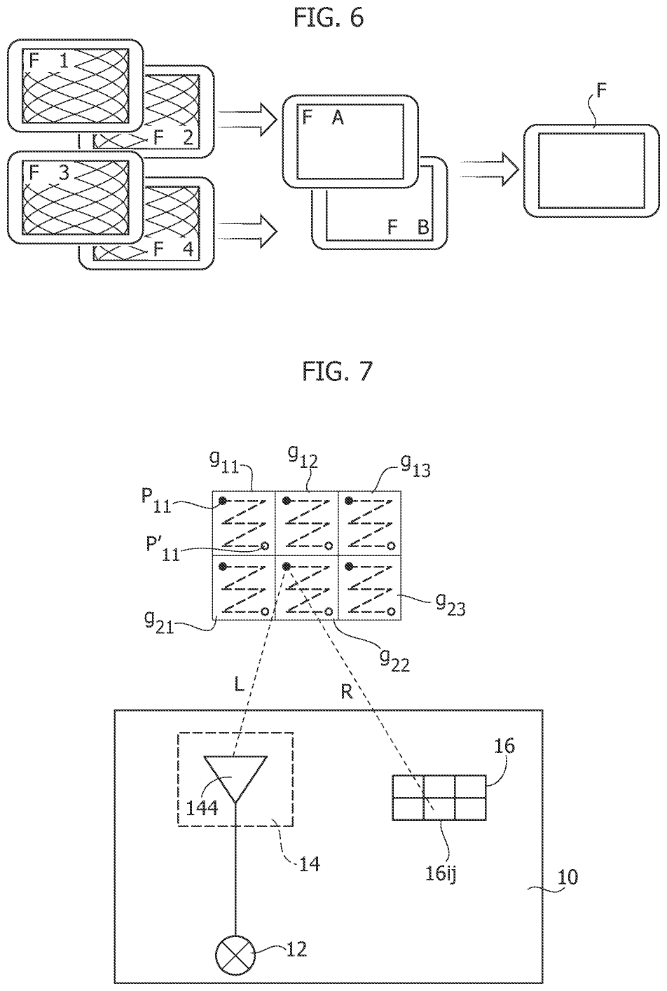

As shown as an example in FIG. 6, a first set of these partial scans may lead to obtaining, for instance using a frame rate of 60 frames per second, a first set of subframes F1, F2 and a second set of subframes F3, F4.

Data points obtained per each of these subframes, black dots represent missing data points in the images of FIG. 6, may correspond to 51% of the full scene.

Subsequently, a method of obtaining an image of the target scene using these subframes may comprise:
pairwise combining subframes in the respective first and second sets of subframes,
providing a first combined subframe Fa, e.g., by combining subframes F1 and F2 therebetween, and a second combined subframe Fb, e.g., by combining subframes F3 and F4 therebetween, the combined subframe having an increased filling rate with respect to the subframes F1, F2, F3, F4 (e.g., 76%),
merging the first and second combined subframes Fa, Fb in a merged frame F, for instance updated at 15 fps (fifteen frames-per-second) and a final fill rate of about 97%.

As shown as an example in FIG. 6, a full Lissajous pattern can be divided into partial patterns, each of which sparsely but rapidly sampled the field of view. For instance, a VGA-like resolution can be obtained by merging together four pictures of smaller resolution, e.g., quarter VGA (QVGA).

It is noted that the example above is one of the possible ways of combining partial frames. In one or more embodiments, other combinations can be employed to reduce the size of the sensor array 16 by increasing the number of Lissajous sub framing, e.g., QQVGA sensor for sixteen frames or 80×60 for an amount of 256 frames.

As shown as an example herein, the apparatus comprises a diffusive optical element (for instance, 160) coupled to the array of sensors and placed intermediate the target and the array of sensors,

groups of SPAD sensors (for instance, 16j) in the array of sensors configured to provide a joint signal indicative of a time of incidence of at least one light pulse (for instance, R, R′) in a joint area of respective grid cells (for instance, g₁₁, g₁₂, g₁₃).

For instance, the diffusive optical element is configured to split the light pulse incident thereon into single photons and to direct each photon towards respective SPAD sensors in the groups of SPAD sensors.

FIG. 7 is an example diagram of an embodiment where the beam steering arrangement comprises optical elements to provide an Optical Phased Array (OPA), configured to split the laser beam from the source 12 in an array of mutually coherent emitters, where the phase difference between each pair of emitters is controlled, e.g., via driving circuitry 20, in order to manipulate the direction of the outgoing combined beam, in a manner known per se.

As shown as an example in FIG. 7, the beam steering arrangement 14 comprises an optical phased array, OPA, 144. For instance, the OPA is capable of steering the light beam L along to the two oscillation axes.

In the example of FIG. 7, a method of performing laser scanning with the apparatus 10 comprises:
partitioning the target surface T according to a grid having in a plurality of grid cells g₁₁, g₁₂, g₁₃, g₂₁, g₂₂, g₂₃, the grid mirroring a same size as the array of sensors 16, e.g., two rows and three columns;
projecting a first light spot (e.g., P₁₁) onto a first, initial, position (e.g., top-left corner) of a first grid cell (e.g., g₁₁),
row-wise iterating projecting a first light spot (e.g., P₁₂, P₁₃) onto the area of a i-th grid cell (e.g., g₁₂, g₁₃) until the last grid element is reached; this may be performed by increasing an index j indicative of the column of the grid while maintaining constant an index i indicative of the row of the grid cell ij-th grid cell;
in some embodiments, after projecting the respective light spot (e.g., P₁₃) onto the last grid element of the row (e.g., g₁₃), row-wise iterating, on grid cells of the second row, projecting a respective light spot (e.g., P₂₁) onto the first position (e.g., top-left corner) but starting from the last grid cell of the row after of the first row (e.g., g₂₃),
upon reaching the end (e.g., g₂₁) of the second row, varying the initial position, for instance following a raster scan curve (indicated in dashed line in FIG. 7), for instance setting a new position (e.g., bottom-right);
projecting a subsequent light spot (e.g., P₁₁′) onto the newly set position (e.g., bottom-right corner) of the first grid cell (e.g., g₁₁),
repeatedly row-wise iterating projecting a subsequent light spot (e.g., P₁₂′, P₁₃′) onto the area of a i-th grid cell (e.g., g₁₂′, g₁₃′) until the last grid element is reached.

In one or more embodiments, an improved resolution may be obtained selecting an OPA 144 with a certain pulse-to-pulse interval, e.g., about 16 (sixteen) nanoseconds (1 nanosecond=1 ns=10⁻⁹ s), and with an array of sensors 16 having a certain size, e.g., sixteen rows and eight columns.

In the example considered, a FullHD (e.g., 1920×1080) at 30 fps (frame-per-second) can be obtained, for instance using a sub-pixel scanning resolution about 120×135. This may result in a maximum detectable distance increased, e.g., from less than 3 meters to more than 300 meters, facilitating use of the instant solution in automotive applications (such as ADAS—Advanced Driver Assistance Systems, for instance). In an embodiment, the beam steering arrangement 14 comprises a multi-stage (e.g., double stage) steering arrangement capable of steering the light beam L along multiple (e.g., two) axes.

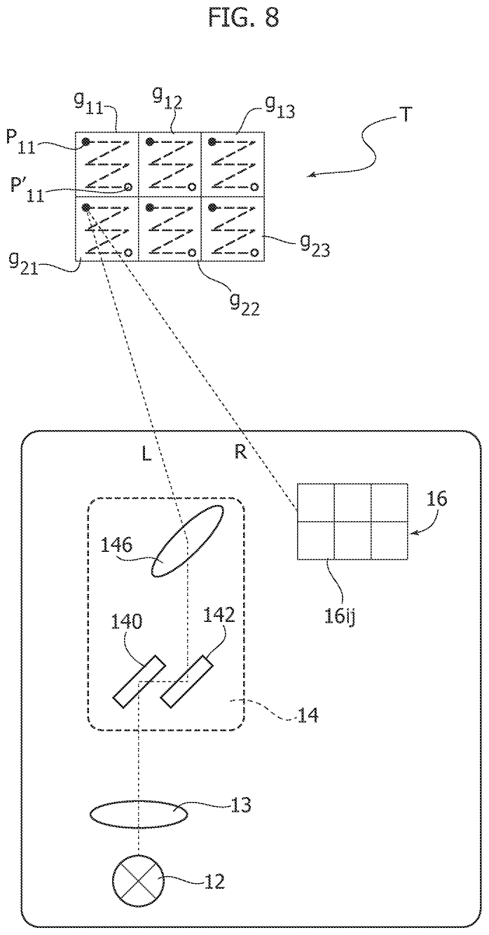

As shown as an example in FIG. 8, the beam steering arrangement 46 may comprise:
a first steering stage (e.g., two orthogonal mirrors 140, 142) configured to direct the laser beam to project a specific light spot (e.g., P11, P11′) on an ij-th grid cell (e.g., g₁₁),
a second steering stage (e.g., a dual axes MEMS lens 146) configured to move the projected light spot within an ij-th grid cell.

As shown as an example in FIG. 8, using this multi-stage arrangement 140, 142, 146 may facilitate increasing the final resolution of the system 10.

For instance, an initial position P11 of the light spot projected for each grid cell element may be varied to improve illumination coverage.

In the example considered in FIG. 8, the double stage arrangement comprises two single stage arrangements being otherwise understood that such an arrangement is purely an example and in no way limiting. For instance, both the first and second beam steering stages can comprise multi-stage and multi-axial arrangements comprising mirrors, lenses, OPA or other suitable optical arrangements.

In an embodiment, elements of the array of sensors 16 can be (sub)grouped together, e.g., column-wise or row-wise, so that a (sub)group is configured to provide a ToF measurement of a cell of the grid.

As shown as an example in FIG. 9, the apparatus 10 comprises a diffusing optical element 150 interposed between the target T and the array of sensors 16. For instance, the diffusing optical element 150 is configured to spread randomly photons corresponding to one reflected laser beam R coming from an ij-th grid cell (e.g., g₁₂) to all sensors in an j-th column 16j of the sensor array 16. For example, the sensor array 16 comprises a SPAD matrix (e.g., of size 2000×32) wherein elements are grouped together column-wise (e.g., thirty-two elements in a j-th column) to provide a single ToF measurement and wherein the diffuser is configured to spread randomly each photon corresponding to one of the (e.g., one thousand, vertical) cells on the entire SPAD column.

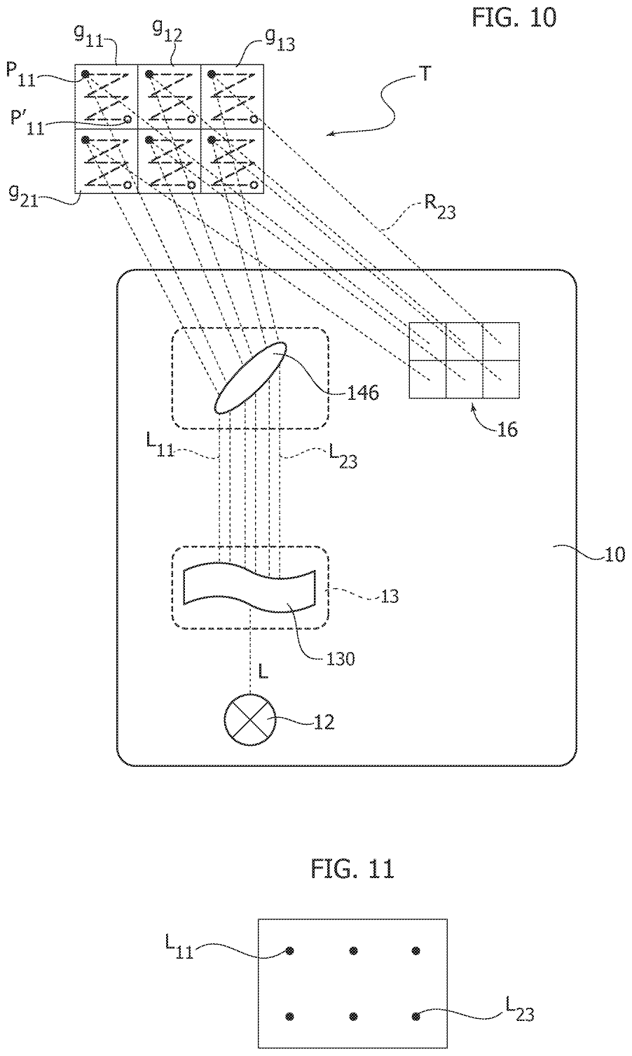

As shown as an example in FIG. 10, a diffractive optical element 130 (briefly, DOE) is suitable for use as beam shaping optics 13 arranged between the laser source 12 and the beam steering arrangement 14.

DOEs are optical elements. These elements exploit diffraction and interference phenomena to generate an arbitrary distribution of (projected) light (spots). A diffractive beam splitter or a diffractive lattice are exemplary DOEs.

As shown as an example in FIG. 10, the DOE 130 is configured to reshape the laser beam L from the laser source 12 into a plurality of light beams L1, . . . , L6 having a plurality of transverse spot sizes forming a matrix of light spots with a size equal to the size of the grid projected onto the target.

As shown as an example herein, the apparatus comprises a diffractive optical element, DOE, (for instance, 130) intermediate the laser source and the beam steering arrangement, the DOE element configured to split the beam of light pulses, providing a plurality of beams of light pulses (for instance, L₁₁, L₂₃) to the beam steering arrangement.

FIG. 11 is an example transverse beam spot-size, e.g., which may be seen by introducing a screen at the chain line in FIG. 10, that can be output by the DOE 130. As shown as an example in FIG. 11, the DOE 130 is configured to that the plurality beams L₁₁, . . . L₂₃ has respective point-like beam spot size arranged in a matrix.

As shown as an example in FIG. 10, the beam steering arrangement 14 comprises a multi-axial steering arrangement, e.g., bi-linear MEMS lens 146, configured to steer each ij-th light spot projected by an ij-th light beam in the plurality of light beams L₁₁, . . . ,L₂₃ within each respective ij-th grid cell (e.g., L₁₁ within g₁₁ and L₂₃ within g₂₃), in different positions therein so as to progressively illuminate, e.g., with a linear pattern, the area of the ij-th grid cell.

As shown as an example in FIG. 10, each ij-th sensor in the array of sensor 16 is configured to detect an ij-th reflected light beam echoed back by the target with proper reflectivity and at a proper distance, providing a respective ij-th TOF measurement as a result.

For instance, the resolution of the system or apparatus 10 shown as an example in FIG. 10 is equal to a resolution of sensor and DOE (e.g., 64×64) times a resolution of the beam steering arrangement 14 (for example, 30×17 resolution of the MEMS lens 146, leading to a total resolution about FHD 1920×1080).

In one or more embodiments, the beam shaping arrangement 13 with the DOE 130 can be further configured to compensate for geometrical distortion of the spot matrix due to the optical projection path (mainly MEMS lens or mirrors).

In one or more embodiments, exploiting MEMS technology facilitated providing a very small, lightweight and fast apparatus/system 10. For example, the lens/mirror can be a few millimeters wide with an oscillating frequency in the range 10-1000 Hz.

As shown as an example herein, a method of operating an apparatus (for instance, 10) as per the present disclosure, comprises:
driving (for instance, 20) the beam steering arrangement (for instance, 14) to cyclically vary the direction of transmission (for instance, α, β) of the light pulses (for instance, P1, P1′) and to transmit at least one light pulse (for instance, P1, P2, P3, P4, P5, P6, P7, P8) per each grid cell portion (for instance, g₁) of the partitioned FOV (for instance, T) of the array of sensors.

As shown as an example herein, the method comprises driving the beam steering arrangement to vary the direction of transmission of the light pulses within each grid cell (for instance, gᵢⱼ) in the portioned FOV (for instance, T) of the array of sensors.

As shown as an example herein, the method comprises:
selecting a pattern among a raster scan pattern and a Lissajous pattern,
driving the beam steering arrangement to cyclically vary the direction of transmission of the light pulses according to the selected pattern.

As shown as an example herein, the method comprises:
collecting signals produced from sensors of the array of sensors, and
calculating (for instance, 20) a measurement of a distance of the target from the apparatus based on the signals collected.

It will be otherwise understood that the various individual implementing options shown as an example throughout the figures accompanying this description are not necessarily intended to be adopted in the same combinations shown as an example in the figures. One or more embodiments may thus adopt these (otherwise non-mandatory) options individually and/or in different combinations with respect to the combination shown as an example in the accompanying figures.

Without prejudice to the underlying principles, the details and embodiments may vary, even significantly, with respect to what has been described by way of example only, without departing from the extent of protection. The extent of protection is defined by the annexed claims.

An apparatus (10) may be summarized as including a laser light source (12) configured to transmit at least one beam of light pulses (L) towards a target, projecting at least one corresponding beam spot (P) thereon, an array of sensors (16) with a plurality of sensors (16i, 16j, 16ij) distributed according to a grid (G), sensors (16i) in the array of sensors (16) configured to sense a light pulse incident thereon in response to reflection of at least one light pulse (P, P1, P1′) of the beam of light pulses (L) from a field of view, FOV, region (T) in the target, sensors (16i) in the array of sensors (16) further configured to provide a signal indicative of a time of incidence thereon of at least one light pulse (R, R′), wherein the FOV region (T) of the array of sensors (16) is portioned into grid cells (gij) according to the grid (G), each sensor (16i) in the array of sensors (16) is configured to sense at least one echo light pulse (R, R′) reflected from a respective grid cell (g1) in the portioned FOV region (T), the apparatus (10) comprises a beam steering arrangement (14) configured to cyclically vary a direction of transmission (α, β) of the beam of light pulses (L), projecting at least one beam spot (P, P1, P1′) per grid cell (gij) in the portioned FOV region (T).

The beam steering arrangement (14) may include a first microelectromechanical, MEMS, mirror (140) configured to oscillate around a first axis with a first oscillating angle (α), and a second MEMS mirror (142) configured to oscillate around a second axis with a second oscillating angle (β), wherein each of the first MEMS mirror (140) and the second MEMS mirror (142) may be coupled to a respective actuating device (A1, A2) configured to drive an oscillating movement of the respective mirror (140, 142).

The first axis of oscillation of the first MEMS mirror (140) and the second axis of oscillation of the second MEMS mirror (142) may be orthogonal therebetween.

The beam steering arrangement (14) may include a MEMS lens (146) coupled to at least one of the first (140) and second (142) MEMS mirrors (140, 142), the MEMS lens (146) configured to vary the direction of transmission (α, β) of the light pulses (P1, P1′) within each grid cell (gij) in the portioned FOV (T) of the array of sensors (16).

The apparatus (10) may include a diffractive optical element, DOE, (130) intermediate the laser source (12) and the beam steering arrangement (14), the DOE element (130) configured to split the beam of light pulses (L), producing a plurality of beams of light pulses (L11, L23) to the beam steering arrangement (14).

The beam steering arrangement (14) may include an optical phased array (144).

At least one sensor (16i) in the array of sensors (16) may include an avalanche photodiode, APD, or a single photon avalanche photodiode, SPAD.

The apparatus (10) may include a diffusive optical element (160) coupled to the array of sensors (16), the diffusive optical element (160) being intermediate the target and the array of sensors (16), groups of SPAD sensors (16j) in the array of sensors (16) configured to provide a joint signal indicative of a time of incidence of at least one light pulse (R, R′) in a joint area of respective grid cells (g11, g12, g13), wherein the diffusive optical element (160) may be configured to split the light pulse incident thereon into photons and to direct the photons towards respective SPAD sensors in the groups of SPAD sensors (16j).

The beam steering arrangement (14) may be configured to cyclically vary the direction of transmission (α, β) of the light pulses (P1, P1′) according to a pattern, for example selected among a raster scan pattern and a Lissajous pattern.

The apparatus (10) may include at least one of a first optical element (15a) coupled to the beam steering arrangement (14), the first optical element (15a) interposed the beam steering arrangement (14) and the target, and a second optical element (15b) coupled to the array of sensors (16), the second optical element interposed the target and the array of sensors (16), wherein the first and/or second optical elements may be configured to counter a Keystone-Pincushion deformation during projecting at least one beam spot (P, P1, P1′) per grid cell (gij) in the portioned FOV region (T).

A method of operating an apparatus (10) may be summarized as including driving (20) the beam steering arrangement (14) to cyclically vary the direction of transmission (α, β) of the light pulses (P1, P1′) and to transmit at least one light pulse (P1, P2, P3, P4, P5, P6, P7, P8) per each grid cell portion (g1, g2, g3, g4, g5, g6, g7, g8) of the partitioned FOV (T) of the array of sensors (16).

The method may include driving (20) the beam steering arrangement (14) to vary the direction of transmission (α, β) of the light pulses (P1, P1′) within each grid cell (gij) in the portioned FOV (T) of the array of sensors (16)

The method may include selecting a pattern among a raster scan pattern and a Lissajous pattern, driving (20) the beam steering arrangement (14) to cyclically vary the direction of transmission (α, β) of the light pulses (P1, P1′) according to the selected pattern.

The method may include collecting signals produced from sensors of the array of sensors (16), and calculating (20) a measurement of a distance of the target from the apparatus (10) based on the signals collected.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An apparatus, comprising:
a laser light source configured to transmit a beam of light pulses towards a target, projecting at least one corresponding beam spot on the target;
a beam steering arrangement; and
an array of sensors arranged according to a grid, a sensor in the array of sensors configured to sense a light pulse incident on the sensor in response to reflection of at least one light pulse of the beam of light pulses from a field of view (FOV) region in the target, the sensor in the array of sensors further configured to provide a signal indicative of a time of incidence of the light pulse on the sensor,
wherein:
the FOV region is portioned into grid cells according to the grid,
each sensor in the array of sensors is configured to sense at least one echo light pulse reflected from a respective grid cell in the FOV region,
the beam steering arrangement is configured to vary a direction of transmission of the beam of light pulses, projecting at least one beam spot per grid cell in the FOV region.

2. The apparatus of claim 1, wherein the beam steering arrangement comprises:
a first microelectromechanical (MEMS) mirror configured to oscillate around a first axis with a first oscillating angle; and
a second MEMS mirror configured to oscillate around a second axis with a second oscillating angle,
wherein each of the first MEMS mirror and the second MEMS mirror is coupled to a respective actuating device configured to drive an oscillating movement of the respective MEMS mirror.

3. The apparatus of claim 2, wherein the first axis of oscillation of the first MEMS mirror and the second axis of oscillation of the second MEMS mirror transverse one another.

4. The apparatus of claim 2, wherein the beam steering arrangement comprises a MEMS lens coupled to at least one of the first and second MEMS mirrors, the MEMS lens configured to vary the direction of transmission of the light pulses within each grid cell in the FOV.

5. The apparatus of claim 1, comprising a diffractive optical element (DOE) arranged between the laser source and the beam steering arrangement, the DOE configured to split the beam of light pulses to produce a plurality of beams of light pulses to the beam steering arrangement.

6. The apparatus of claim 1, wherein the beam steering arrangement comprises an optical phased array.

7. The apparatus of claim 1, wherein the sensors comprise an avalanche photodiode (APD) or a single photon avalanche photodiode (SPAD).

8. The apparatus of claim 1, comprising:
a diffusive optical element coupled to the array of sensors, the diffusive optical element arranged between the target and the array of sensors;
SPAD sensors in the array of sensors configured to provide a joint signal indicative of a time of incidence of at least one light pulse in a joint area of respective grid cells,
wherein the diffusive optical element is configured to split the light pulse incident on the diffusive optical element into photons and to direct the photons towards respective SPAD sensors.

9. The apparatus of claim 1, wherein the beam steering arrangement is configured to cyclically vary the direction of transmission of the beam of light pulses according to a pattern selected among a raster scan pattern or a Lissajous pattern.

10. The apparatus of claim 1, comprising at least one of:
a first optical element coupled to the beam steering arrangement, the first optical element interposed between the beam steering arrangement and the target, or
a second optical element coupled to the array of sensors, the second optical element interposed between the target and the array of sensors,
wherein the at least one of the first optical element or the second optical element is each configured to counter a Keystone-Pincushion deformation during projecting the at least one beam spot per grid cell in the FOV region.

11. A method comprising:
providing an array of sensors arranged according to a grid, a sensor in the array of sensors configured to sense a light pulse incident ton the sensor in response to reflection of at least one light pulse of a beam of light pulses from a field of view (FOV) region in a target;
partitioning the FOV region into grid cells according to the grid;
projecting at least one beam spot per grid cell in the FOV region by driving a beam steering arrangement to vary a direction of transmission of light pulses; and
receiving a signal from each sensor in the array of sensors indicative of at least one echo light pulse reflected from a respective grid cell in the FOV region.

12. The method of claim 11, wherein the driving the beam steering arrangement to vary the direction of transmission of the light pulses includes driving the beam steering arrangement to cyclically vary the direction of transmission of the light pulses within each grid cell in the FOV.

13. The method of claim 11, comprising:
selecting a pattern among a raster scan pattern or a Lissajous pattern,
driving the beam steering arrangement to cyclically vary the direction of transmission of the light pulses according to the selected pattern.

14. The method of claim 11, comprising:
calculating a measurement of a distance of the target from the array of sensors based on the signals received.

15. A system, comprising:
a laser light source configured to transmit a beam of light pulses towards a target;
a beam steering arrangement including a plurality of optical components configured to vary a direction of transmission of the beam of light pulses; and
an array of sensors arranged according to a grid, a sensor in the array of sensors configured to sense a light pulse incident on the sensor and to provide a signal indicative of a time of incidence of the light pulse on the sensor.

16. The system of claim 15, wherein the plurality of optical components include a first mirror and a second mirror.

17. The system of claim 16, wherein the first mirror is configured to rotate along a first axis with a first frequency, and the second mirror is configured to rotate along a second axis with a second frequency.

18. The system of claim 17, wherein the first axis and the second axis transverse one another.

19. The system of claim 16, wherein the first mirror is configured to steer the beam of light pulses along a first angle, and the second mirror is configured to steer the beam of light pulses along a second angle having a different degree from the first angle.

20. The system of claim 16, wherein the plurality of optical components include a biaxial MEMS mirror suitable to rotate along two orthogonal axes.
